(19) United States
(12) Patent Application Publication
(10) Pub. No.: US 2012/0298553 A1
(43) Pub. Date: Nov. 29, 2012

(54) PREDICTING PETROLEUM COKE MORPHOLOGY FROM FEEDSTOCK PROPERTIES

(75) Inventor: Jared Fern, Avondale, PA (US)

(73) Assignee: LYONDELL CHEMICAL COMPANY, Houston, TX (US)

(21) Appl. No.: 13/117,446

(22) Filed: May 27, 2011

(51) Int. Cl. C10G 99/00; B01J 19/00

(52) U.S. Cl. 208/106; 422/68.1

(57) ABSTRACT

A method of predicting the morphological type of coke produced in a delayed coking process is provided by measuring S-values of an asphaltene containing feedstock with an S-value machine. Improved refinery operations and delayed coking operations can be obtained by virtue of the invention.

### BACKGROUND OF THE INVENTION

1. Field of the Invention

This invention relates to the formation of coke by the delayed coker process. The coke formed can be a fuel grade coke, classified as either sponge coke or shot coke. The type of coke produced can be predicted from a preliminary testing of the feedstock to improve coke morphology.

2. Description of the related art

Delayed coking is a thermal cracking process used in petroleum refineries to upgrade and convert petroleum residuum (bottoms from distillation of crude oil) into liquid and gas product streams leaving behind a solid, concentrated carbon material, petroleum coke (hereinafter “coke”). Petroleum coke was first made by the pioneer oil refineries of Northwestern Pennsylvania in the 1860's. Those primitive refineries boiled crude oil in small, iron stills to recover kerosene, a valuable and much needed luminescent. The stills were heated by wood or coal fires built underneath the still which over-heated and coked the oil near the bottom. After the distillation was complete, the still was allowed to cool so that workmen could dig out the coke and tar before the next run.

The origin of the vertical coke drum was probably from thermal cracking of gas oil for the production of gasoline and diesel fuel. From 1912 to 1935 the Burton process developed by Standard Oil at Whiting, Indiana converted gas oil to gasoline with the production of petroleum coke. The lack of an adequate supply of crude oil and the lack of a heavy oil market caused land-locked middle American refineries to process the heavy fuel oil (atmosperic distillation bottoms and vacuum distillation bottoms) in a delayed coker to produce more gasoline and diesel fuel.

Delayed coking combined a number of the features and improvements from the development of the thermal cracking process. The use of pressure as well as heat for cracking and separating the heater from the coker and the use of two coking drums enabled the delayed coker to operate on a continuous basis. The number of cokers built before 1955 was small, with a surge in delayed coker construction between 1955 and 1975 at 6% per year and an 11% growth rate during the 1965 to 1970 period. The growth of delayed cokers was in step with the growth of fluid catalytic cracking and rapid decline in thermal cracking.

Today, the delayed coker is the only main process in a modern petroleum refinery that is a batch-continuous process. A schematic of a basic refinery is shown in FIG. 1. The flow through the tube furnace is continuous. The feed stream is switched between the two coker drums. One drum is on-line filling with coke while the other drum is being steam stripped, cooled, decoked, pressure checked and warmed up. The overheat vapors from the coke drums flow to a fractionator, usually called a combination tower. The fractionator, or combination tower, has a resevoir in the bottom where the fresh feed is combined with condensed product vapors (recyle) to make up the feed to the coker heater.

A basic coker operation flow diagram is shown as FIG. 2 to illustrate some of the delayed coking unit hardware.

Coke drum diameters range from 4 to 9 meters (13 to 30 feet) with the straight side being about 25 meters (82 feet) with a 1.5 meter diameter top blind flange closure and a 2 meter diameter bottom blind flange in which a 15 to 30 cm inlet nozzle is attached. Both the top blind flange and bottom blind flange must be removed when decoking the drum. The pressure in the drum ranges from 1 to 5.9 bars, typically about 2 to 3 bars.

A high pressure water jet is employed to cut the coke out of the drum, but other mechanical removal methods can be employed.

The physical structure of coke can be broken down into three main types, shot coke, sponge coke and needle coke. Shot coke is in the form of balls of 2 to 5 mm in size, but can agglomerate into larger balls as large as 25 centimeters. Sponge coke is named for its sponge-like appearance. One manner of influencing the production of sponge coke is disclosed in U.S. Pat. No. 4,096,097. Needle coke is named for its needle-like structure. Needle coke is produced from feedstocks without asphaltenes present. Such production requires special feedstocks and other special processing parameters as disclosed in U.S. Pat. No. 4,490,244. There are various methods for determining the properties, such as luster, of coke such as disclosed in U.S. Pat. No. 6,954,545, among others. However, none of these disclosures can predict the type of coke which will be produced from any given asphaltene-containing feedstock.

When crudes are processed where blends of shot coke and sponge coke are produced, the shot coke, composed of spherical particles, tend to agglomerate together. When this happens, regions within the coke drum do not cool as efficiently as the rest of the drum creating operational problems when cutting the coke out of the drum with high pressure water. Such operational problems are known as “hot spots” and “steam eruptions” when subsequently cutting the coke with a high pressure jet of water.

There are some techniques available in the literature for prediction of coke morphology. The most prevalent technique involves measuring the ratio of the microcarbon residue (hereinafter “MCR”) to the quantity of asphaltenes present in the resid. If this ratio is less than 2, the resid will produce primarily shot coke. If the ratio is higher than 2, the resid will produce primarily sponge coke. The MCR to asphaltene ratio is based upon historical plant experience and is engrained in coking lore, but this ratio is only accurate at the extremes of the morphology spectrum and not at the intermediate values that are typically found in refineries.

A second approach found in the literature is to experimentally measure the quantity of aromatic carbon and heteroatoms (O, S, N) present in a precipitated asphaltene sample. If the ratio is greater than 11 then primarily sponge coke will be formed and if the ratio is less than 7 primarily shot coke will be formed. The region between 7 and 11 is a transitional region where the coke can create hot spots. This technique does not quantify the intermediate resids processed at some refineries, and the analysis is difficult to perform in a timely manner without specialized equipment. Furthermore, each of these techniques add an additional error to the measurement because the resid suspension is broken to remove the asphaltene molecules for analysis. Another approach is disclosed in U.S. Pat. No. 7,803,627.

Thus, there exists a need to predict the type of coke to be produced in a delayed coker, based on the asphaltene containing feedstock used in the refinery

Each of the foregoing U.S. Patents are herein incorporated by reference in their entireties.

### BRIEF SUMMARY OF THE INVENTION

The stability of a solution that contains asphaltenes can be measured using an S-value machine. An S-value machine is an analytical apparatus that measures the stability of heavy fuels. One such machine is available from ROFA FRANCE from the manufacturer, DPC SA of Grand Rue 86 CH-20075 Thielle-Wavre, SWITZERLAND. The parameters generated from the stability analysis are typically used to determine if two different crude oils are compatible for blending.

In one embodiment according to the present invention, the parameters measured by an S-value machine are used to predict the type of coke produced from a given asphaltene containing feedstock.

In another embodiment of the invention a delayed coking apparatus is utilized to primarily produce either shot coke or sponge coke.

These and other embodiments of the invention will become apparent when reading the following detailed description of preferred embodiments in connection with the appended drawings.

### BRIEF DECRIPTION OF THE DRAWINGS

FIG. 1 is a schematic drawing of a typical refinery;

FIG. 2 is a schematic diagram of a basic delayed coker unit with related hardware; and,

FIG. 3 is a graphic representation of a plot of various feedstocks versus S-values (and the conventional Aromatic Carbon/Sum (N+S+O)) and the resulting production of either shot coke or sponge coke.

### DETAILED DECRIPTION OF THE PREFERRED EMBODIMENTS

In order to visualize the relative position of a delayed coker in a typical refinery, FIG. 1 is a schematic representation of a refinery where the bottoms of a coker fractionator, together with recycled vapor from the coking drums fed to the coker fractionator, are used as a feedstock to the coking drums. As previously explained the coking drums are batch process equipment, in an otherwise continuous process, such that a switch valve is used to divert the coking drum feedstock to one or the other of two coking drums, such that one can be filling and making coke, while the other has formed coke being removed therefrom.

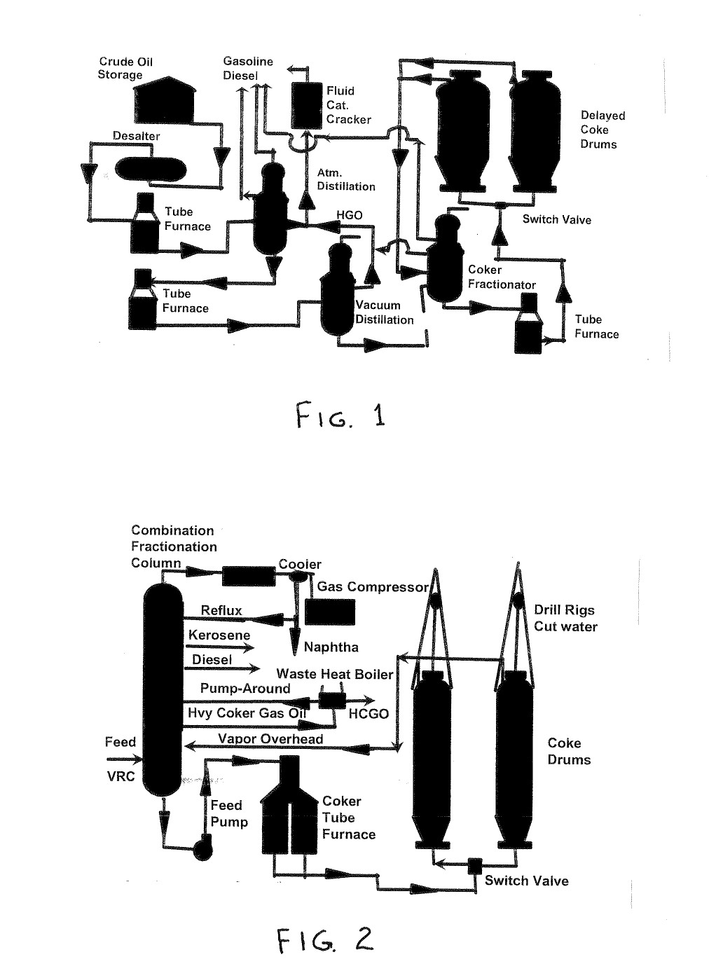

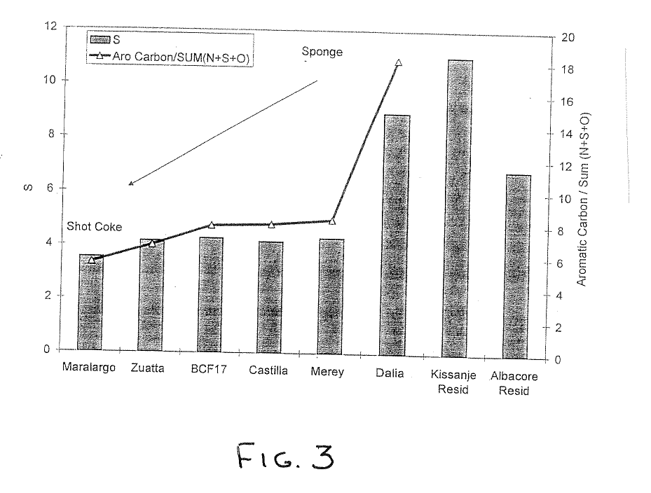

The basic flow diagram of a coking operation is shown in FIG. 2. What is heretofore unknown, or possible to only approximate, is what type of coke will be produced in the coking drums.

Therefore, acccording to a first embodiment of the invention, various feedstocks to a coking operation are analyzed by an S-value machine. The S-value machine analyzes various crude oils to see if they are compatible for blending. However, according to the present invention, the parameters, S, generated by an S-value machine of varied feedstocks are plotted against various feedstocks (containing the ratio of Aromatic Carbon divided by the Sum of heteroatoms (N+S+O) indicated).

Therefore for feedstocks identified as Maralargo, Zuatta, BCF17, Castilla, Merey, Dalia, Kissanje Resid, and Albacore Resid, in FIG. 3, (having corresponding ratios of aromatic carbon divided by the sum of heteroatoms (N+S+O)), the resulting S-values show that shot coke will primarily be produced while sponge coke will decrease, as plotted.

It will know be possible to predict the type of coke produced in a delayed coker by knowing the S-value generated by an S-value machine for any given feedstock.

In a second emodiment according to the invention, it will be possible to use a delayed coking apparatus to produce the desired morphology of coke.

Thus, it will be evident to those reading the present disclosure to modify the same to suit their particular feedstocks, coking drum design and S-value machine available, without departing from the spirit or scope of the invention claimed in the appended claims.

### Example

In order to determine the type of coke from a process, the following protocol can be carried out. A sample of vacuum resid is obtained from either a process stream from a refinery or from a distilled sample of crude oil such as Merey, BCF-17, Maralago, and Castilla.

Three different quantities of the vacuum resid are measured out and the samples placed into containment cells. The samples are often solid at room temperature, accordingly, the sample may require heating and thus may be warm before taking a measurement.

Approximately 10 ml of toluene is added to each of the cells and the sample is refluxed for a minimum of 2 hours at elevated temperature (approximately 200° F.).

Once the sample has been refluxed for 2 hours, allow sample is cooled to room temperature and the cells are placed into the sample holder.

The probes of the S value machine are gently placed into the samples in the S-value machine for processing.

Once processing begins, heptane is fed to the individual cells. Heptane will continue to be fed until the probe detects flocculation within the sample.

After all of the samples have flocculated, the test is complete.

The S-value machine with the help of software calculates the values of S, Sa, and So. S represents the global stability of the sample. Sa is the peptizing of an asphaltene to remain colloidal dispersed, and So is the power of peptization of the residual fuel medium.

The value of S can be used to determine what kind of coke a vacuum resid will typically form. This information can be determined by comparing the value of S to the information in FIG. 3. Additionally, the Salues provided in FIG. 3 were obtained using the above noted procedure.

I Claim:

1. In a method of forming coke in a delayed coking apparatus comprising at least a first coking drum fed with an asphaltene containing resid from an asphaltene containing feedstock, the improvement comprising analyzing the asphaltene containing feedstock with an S-value machine, obtaining the S-value parameters from the machine and predicting whether the feedstock will produce primarily shot coke or sponge coke.

2. The method of claim 1, wherein the feedstock is one selected from the group consisting of Maralargo, Zuatta, BCF17, Castilla, Merey, Dalia, Kissanje Resid and Albacore Resid.

3. The method of claim 1, further comprising a second coking drum and a switch valve and feeding the resid of the asphaltene containing feedstock with the switch valve to either the first or the second coking drum.

4. The method of claim 1, further comprising heating the resid of the asphaltene containing feedstock prior to introduction into the at least a first coking drum.

5. The method of claim 1, further comprising obtaining the resid of the asphaltene containg feedstock from the bottoms of a coker fractionator.

6. The method of claim 1, further comprising the step of uniformly cooling the coke produced in the at least one coking drum.

7. The method according to claim 1, further comprising recovering primarily shot coke.

8. The method according to claim 5, furher comprising feeding a recyle stream obtained from the vapors of the at least one coking drum into the coking fractionator.

9. In a refinery producing at least gasoline and diesel fuel from an asphaltene containing feedstock by at least one of atmospheric distillation and catalytic cracking, and further increasing the yield of at least one of gasoline and diesel fuel by feeding the bottoms of a vacuum distillation to a coker fractionator, the improvement comprising predicting the type of coke produced from the resid of the coke fractionator by analyzing the asphaltene containing feedstock with an S-value machine.

10. The refinery of claim 9, wherein the asphaltene containing feedstock is one selected from the group consisting of Maralargo, Zuatta, BCF17, Castilla, Merey, Dalia, Kissanje Resid and Albacore Resid.

11. The refinery of claim 9, wherein the coke produced is primarily shot coke.

12. An apparatus for predicting the morphological type of coke produced in a delayed coking apparatus, comprising:
at least a first coking drum;
a source of a resid of an asphaltene containing feedstock operatively connected as an input to said at least first coking drum; and,
an S-value machine to measure parameters of an asphaltene containing feedstock which forms the resid.

13. The apparatus of claim 12, further comprising a second coking drum and a switch valve to divert the resid to one of the first or second coking drums.

14. The apparatus of claim 13, further comprising a coker fractionator as the source of the resid.

15. The apparatus of claim 14, further comprising a heater operatively connected between said coker fractionator and switch valve.

16. The apparatus of claim 15, further comprising a recyle conduit between a vapor effluent of at least one of said first and second coking drums and said coker fractionator.

17. The apparatus of claim 16, further comprising water jet cutting elements to remove coke from the at least one of said first and second coking drums.
